(19) United States
(12) Patent Application Publication
(10) Pub. No.: US 2016/0066564 A1
(43) Pub. Date: Mar. 10, 2016

(54) PERFUSION SYSTEMS AND METHODS OF PERFUSING AT LEAST A PORTION OF A SMALL INTESTINE

(71) Applicant: Yale University, New Haven, CT (US)

(72) Inventors: John P. Geibel, Branford, CT (US); Joseph Zinter, Guilford, CT (US); Manuel Rodriguez-Davalos, Woodbridge, CT (US); Roger Patron-Lozano, New Haven, CT (US); Spencer Backus, New Haven, CT (US); Andrew Crouch, Chevy Chase, MD (US); Brian Loeb, Old Westbury, NY (US); Raja Narayan, Union City, CA (US); Kristi Oki, Trumbull, CT (US); Natalie Pancer, Boca Raton, FL (US)

(21) Appl. No.: 14/674,678

(22) Filed: Mar. 31, 2015

Related U.S. Application Data
(60) Provisional application No. 62/046,467, filed on Sep. 5, 2014.

(51) Int. Cl. A01N 1/02

(52) U.S. Cl. CPC A01N 1/0247; A01N 1/0226

(57) ABSTRACT

One embodiment of the invention provides a perfusion system including: a first circuit adapted and configured to circulate a first perfusate through a lumen of a small intestine and a second circuit adapted and configured to circulate a second perfusate through one or more blood vessels of the small intestine. Another aspect of the invention provides a method of perfusing at least a portion of a small intestine. The method includes: circulating a first perfusate through a lumen of the small intestine and circulating a second perfusate through a blood vessel of the small intestine.

### CROSS-REFERENCE TO RELATED APPLICATION

This application claims priority under 35 U.S.C. §119(e) to U.S. Provisional Patent Application Ser. No. 62/046,467, filed Sep. 5, 2014. The entire content of this application is hereby incorporated by reference herein.

### BACKGROUND OF THE INVENTION

Patients with short bowel syndrome or intestinal failure often rely on total parenteral nutrition (TPN) for support, which not only leads to a low quality of life but may also lead to complications such as depletion of central veinous access and cholestatic liver disease if used chronically. In addition, TPN is expensive, ranging from $100,000-200,000 per year. As an alternative treatment, intestine transplantation costs around $150,000-200,000 and can lead to drastic improvements in quality of life.

While the rate of intestine transplants has increased due to advances in immunosuppression and surgical devices, the surgery remains the least commonly performed transplant procedure, with only 100-200 performed annually.

### SUMMARY OF THE INVENTION

One embodiment of the invention provides a perfusion system including: a first circuit adapted and configured to circulate a first perfusate through a lumen of a small intestine and a second circuit adapted and configured to circulate a second perfusate through one or more blood vessels of the small intestine.

This aspect of the invention can have a variety of embodiments. The first circuit can include: a first perfusate reservoir; a first length of tubing coupled to the first perfusate reservoir; a second length of tubing coupled to the first perfusate reservoir; and a first pump adapted and configured to circulate the first perfusate from the first perfusate reservoir to the first length of tubing and through the lumen of the small intestine to the second length of tubing. The perfusion system can further include: a first fitting coupled to the first length of tubing and adapted and configured to form a substantially fluid-tight coupling with a first end of the lumen of the small intestine and a second fitting coupled to the second length of tubing and adapted and configured to form a substantially fluid-tight coupling with a second end of the lumen of the small intestine. The first fitting and the second fitting can be Christmas tree fittings. The first pump can be a peristaltic pump.

The second circuit can include: a second perfusate reservoir; a third length of tubing coupled to the second perfusate reservoir; a fourth length of tubing coupled to the second perfusate reservoir; and a second pump adapted and configured to circulate the second perfusate from the second perfusate reservoir to the third length of tubing and through the one or more blood vessels of the small intestine to the fourth length of tubing. The perfusion system can further include: a third fitting coupled to the third length of tubing and adapted and configured to form a substantially fluid-tight coupling with a first end of the one or more blood vessels of the small intestine and a fourth fitting coupled to the fourth length of tubing and adapted and configured to form a substantially fluid-tight coupling with a second end of the one or more blood vessels of the small intestine. The third fitting and the fourth fitting can be Christmas tree fittings. The second pump can be a peristaltic pump.

Another aspect of the invention provides a method of perfusing at least a portion of a small intestine. The method includes: circulating a first perfusate through a lumen of the small intestine and circulating a second perfusate through a blood vessel of the small intestine.

This aspect of the invention can have a variety of embodiments. The second perfusate can be recovered both from a vein and from a container below the small intestine. The first perfusate and the second perfusate can be circulated simultaneously. The first perfusate and the second perfusate can have a substantially identical composition. The first perfusate and the second perfusate can be hypothermic perfusates. The first perfusate and the second perfusate can be maintained between about 4° C. and about 8° C. The first perfusate and the second perfusate can be room temperature perfusates. The first perfusate and the second perfusate can be normothermic perfusates.

Another aspect of the invention provides a perfusion system including: a first circuit adapted and configured to circulate a first perfusate through a lumen of a small intestine; a second circuit adapted and configured to circulate a second perfusate through one or more blood vessels of the small intestine; and a container adapted and configured to hold the small intestine and collect perfusate that leaks from the small intestine. The container is in fluidic communication with the second circuit so that the collected perfusate is recirculated through one or more blood vessels of the small intestine.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a schematic of a dual-perfusion system according to an embodiment of the invention;

FIG. 2 is a schematic of a dual-perfusion system according to an embodiment of the invention;

FIG. 3 depicts an electronic controller according to an embodiment of invention;

FIG. 4 depicts the exterior of a dual-perfusion system according to an embodiment of the invention;

FIG. 5 depicts a method of perfusion according to an embodiment of the invention;

FIG. 6 depicts the interior of a dual-perfusion system according to an embodiment of the invention;

FIG. 7A is a photograph of a small intestine after perfusion with an embodiment of the invention;

FIG. 7B is a photograph of a control small intestine;

FIG. 8A is a microscopic slide of a hematoxylin-and-eosin-stained histologic specimen of a small intestine after perfusion with an embodiment of the invention;

FIG. 8B is a microscopic slide of a hematoxylin-and-eosin-stained histologic specimen of a control small intestine;

FIG. 9 is a graph of the temperature of the small intestine over time during perfusion with an embodiment of the invention; and

FIG. 10 is a graph of the association between control voltages and pump flow rate according to an embodiment of the invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

“Hypothermic” shall be understood to mean temperatures below room temperature. For example, “hypothermic” temperatures include, but are not limited to, temperatures between about 0° C. to about 15° C., temperatures between about 1° C. to about 8° C., temperatures between about 3° C. to about 5° C., and the like.

“Normothermic” shall be understood to mean temperatures above room temperature. For example, “normothermic” temperatures include, but are not limited to, temperatures between about 25° C. and about 42° C., temperatures between about 30° C. and about 38° C., temperatures between about 37° C. and about 37.5° C., and the like.

“Room temperature” shall be understood to mean a temperature between about 15° C. and about 25° C. For example, “room temperature” includes, but is not limited to, temperatures between about 18° C. and about 23° C., temperature between about 19° C. and about 21° C., temperatures between about 24° C. and about 25° C., temperatures between about 20° C. and about 21° C., and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Aspects of the invention provide systems, perfusates, and methods for perfusion of the intestinal lumen and vasculature to better preserve the small intestine during transport. Blood and lumen perfusion of the organ with a preservation solution slows degradation of the tissue by preventing cellular waste that may build up due to normal metabolic activity, and prevents necrosis.

### Dual-Perfusion

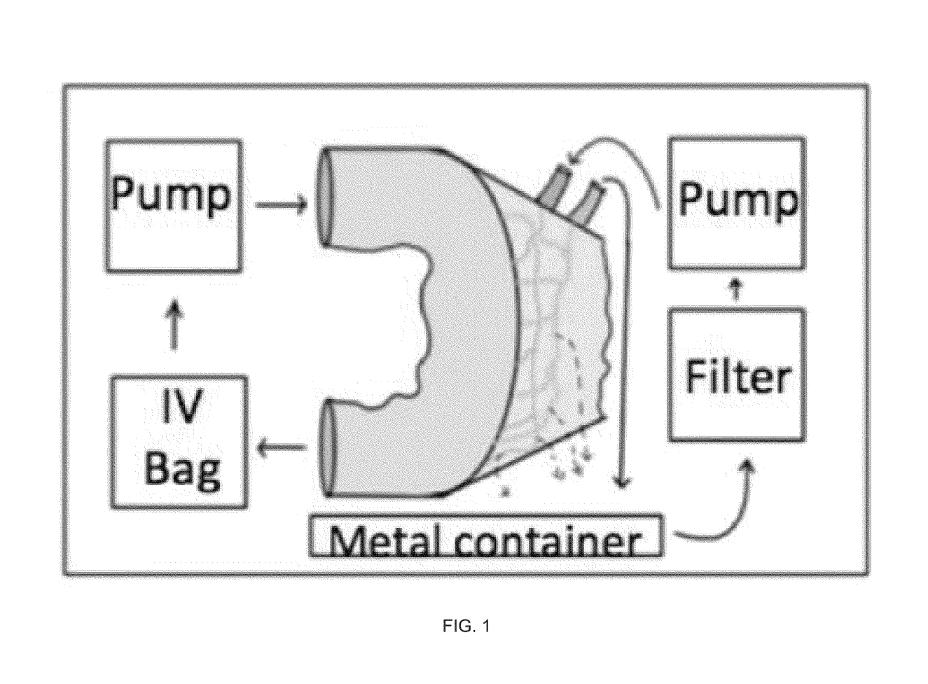

Aspects of the invention utilize a dual-perfusion approach depicted in FIG. 1 in which a perfusate is circulated both through the lumen of the intestine as well as through the vasculature of the intestine. In some embodiments, the luminal circuit is a closed circuit in which all substantially all perfusate introduced to a first end of the lumen is recovered at a second end of the lumen for recirculation. In some embodiments, the vascular circuit is an open circuit that anticipates leakage from the vasculature due to microperforations made while resecting the organ from the body and recovers perfusate that leaks from these microperforations as well as from one or more veins for recirculation. Such an open system can collect leaked perfusate from the container holding the organ.

### Perfusion System

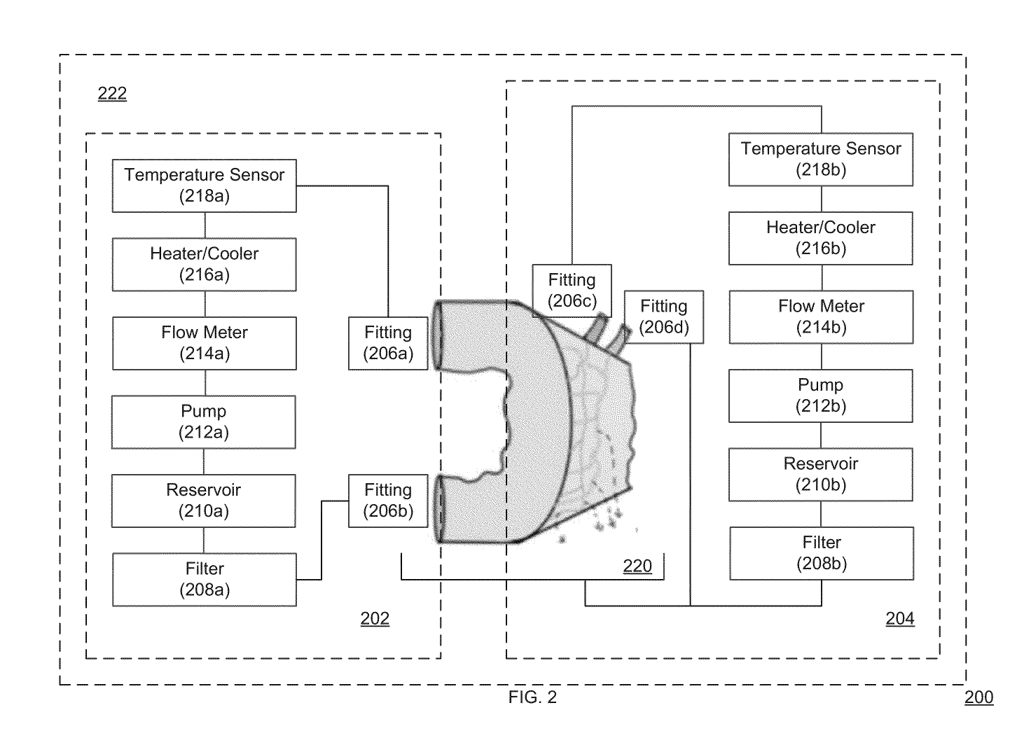

Referring now to FIG. 2, a perfusion system 200 is provided. The system 200 includes a first circuit 202 and a second circuit 204. Circuits 202, 204 can, but need not necessarily, include the many of the same or similar components. For example, one or more of circuits 202, 204 can include a pair of fittings 206 adapted and configured for coupling with a lumen and/or a blood vessel of the small intestine. The circuits 202, 204 can also include one or more of a filter 208, a reservoir 210, a pump 212, a heating/cooling element 214, and a temperature sensor 216. The circuit components can be coupled by various tubing, which can be medical-grade, biocompatible tubing made from a material such as silicone and the like.

A variety of fittings 206 can be utilized to create a substantially fluid-tight coupling between tubing and either a lumen and a blood vessel. In one embodiment, the lumen and the blood vessels are sutured over barbed fittings. In some embodiments, the barbed fittings are conical “Christmas tree”-style fittings that have a tapered diameter that can accommodate a range of lumens and blood vessels diameters. In other embodiments, a compressible elastomeric or inflatable fitting can be utilized. In still another embodiment, an elastic band or inflatable cuff can be positioned outside of the lumen or blood vessel to compress either the lumen or a blood vessel over a fitting 206.

Filter 208 can be adapted to remove various particles, gases, waste products, or undesired substances from the perfusate. A variety of filters, such as mesh filters, are known in the perfusion field.

Reservoir 210 can be an intravenous fluid bag or other container capable of receiving an storing a perfusate.

Pumps 212 can be any device capable of generating fluid flow. In one embodiment of the invention, peristaltic pumps are used. Advantageously, peristaltic pumps can act on the outside of the tubing for ease of cleaning and reuse and also generate a pulsed fluid flow that best approximates anatomical conditions.

Flow meter 214 can measure the speed of the perfusate through tubing. A variety of flow meters 214 are available including digital flow meters, ultrasound-based flow meters, and the like.

Heating/cooling element 216 can be any element capable of heating or cooling a perfusate in order to maintain a desired perfusion temperature (e.g., for cold or warm perfusion). Suitable heating/cooling elements 216 include Peltier or thermoelectric coolers, ice blocks or cubes, and Joule/ohmic/resistive heaters.

Temperature sensors 218 can include a variety of physical and electrical thermometers, thermocouples, and the like. In one embodiment, temperature sensors can include or be coupled with a temperature display for monitoring during perfusion. In order embodiments, temperature sensors 218 can be coupled with heating/cooling element 214 in a feedback loop to maintain a specified temperature or range of temperatures or with a controller for monitoring, control, and/or communication to another device.

The second perfusion circuit 204 can also include a container 220 adapted and configured to hold the small intestine and collect perfusate that leaks from microperforations in blood vessels. The container 220 can be coupled to the tubing of the second perfusion circuit 204 so that this fluid is recovered and recirculated. In one embodiment, a stainless steel container is used.

Both circuits 202, 204 can be located within a container 222, which is preferably insulated and/or sealed from outside contaminants. In some embodiments, the container 222 is an off-the-shelf cooler. One or more components 208, 210, 212, 214, 216, 218 can be located outside of cooler 222.

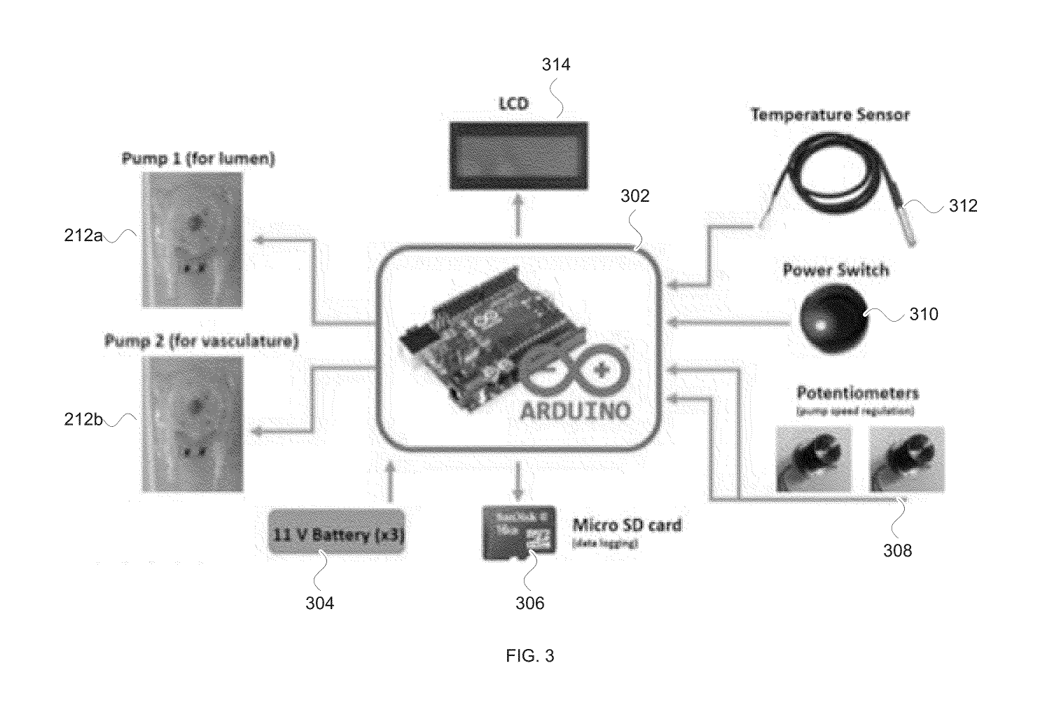

Referring now to FIG. 3, in one embodiment, system 200 can include an electronic controller 302 programmed to monitor, report, and/or control the operation of system 200. Such a controller 302 can be fabricated using a variety of electronics architectures such as an ARDUINO® microcontroller. The microcontroller 302 can be coupled to one or more power sources 304 (e.g., one or more batteries such as lithium polymer batteries), memory devices 306 (e.g., a micro SD card), potentiometers 308, power switches 310, temperature sensors 312, display devices 314 (e.g., a liquid crystal display), and pumps 212. Electronic controller 302 can contain or load one or more computer-readable program instructions for implementing one or more algorithms to maintain a desired temperature, flow rate, and the like. In some embodiments, the user can adjust one or more parameters of the system.

Electronic controller 302 can track and display device 314 can display various data such as flow rate, temperature, and time elapsed since perfusion began.

In one embodiment, the system complies with IEC 60601-1 standard, for example by protecting the batteries from shorting via a polyfuse F1 for overcurrent protection.

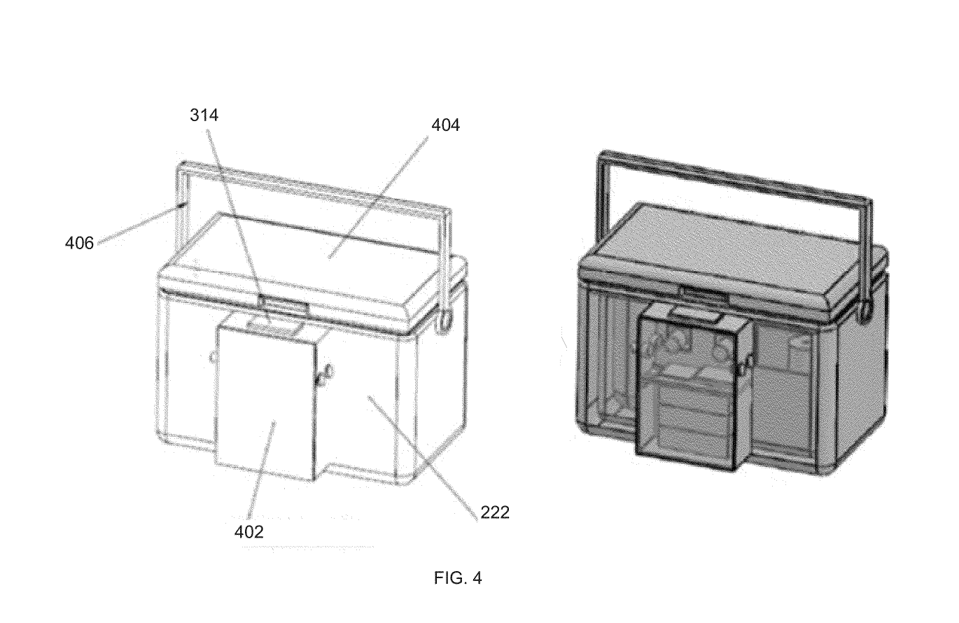

Referring now to FIG. 4, one or more electronic components can preferably be housed outside of container 220 in order to isolate the electronic components from the cold, humid environment inside the container 220. An external box 402 can be coupled to the exterior of container 220 to house one or more of the electronic components. Container 220 can also include a lid 404 and a handle 406.

Aspects of the invention can be lightweight and small enough for conventional travel, and capable of being carried by one person. Additionally, the device can operate for at least eight hours to ensure an adequate travel window.

### Perfusates

A variety of perfusates can be utilized in the dual-perfusion systems and methods described herein.

In one embodiment, the perfusate is University of Wisconsin solution as described in J. H. Southard & F. O. Belzer, “Organ preservation,” 46(1) Annu Rev. Med. 235-47 (1995) and F. Miihlbacher et al., “Preservation solutions for transplantation,” 31(5) Transplant Proc. 2069-70 (1999).

In another embodiment, the perfusate is a high calcium, low sodium solution. Such a solution advantageously minimizes swelling and bursting of cells caused by high sodium solutions.

In still another embodiment, blood (e.g., blood from the donor of the small intestine) can be utilized as a perfusate.

In still another embodiment, a blood substitute, artificial blood, or blood surrogate can be utilized as a perfusate. For example, the perfusate can be a colloidal oxygen substitute.

The perfusates can be hypothermic, room temperature, or normothermic perfusates.

### Perfusion Methods

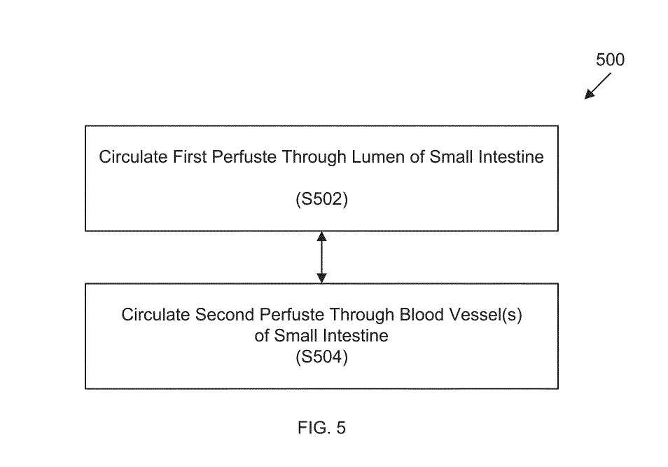

Referring now to FIG. 5, a method 500 of perfusing a small intestine is provided. In step S502, a first perfusate is circulated through a lumen of the small intestine. In step S504, a second perfusate is circulated through one or more blood vessels of the small intestine.

In addition to perfusion during transportation of a small intestine from a donor to a recipient, the system, perfusates, and methods described herein can also be used to preserve a small intestine while surgical procedures are performed in the vicinity of the small intestine. For example, an organ preservation device as described herein would enable the removal of the small intestine and maintain its stability during surgery before being placed back in the body.

### Working Example #1

### Perfusion System

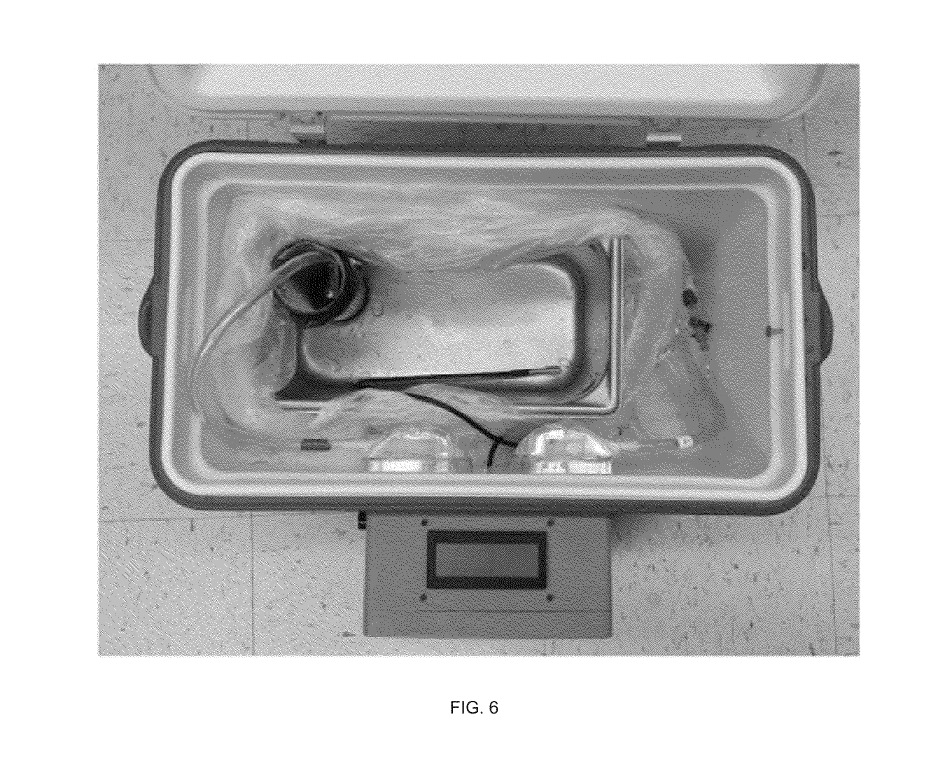

Referring now to FIG. 6, an exemplary perfusion system is depicted. A standard 28-quart cooler was chosen as the foundation of the device. Ice, as opposed to an active thermoelectric cooling system, was employed due to its low cost, availability, and efficiency at cooling. Peristaltic pumps were used to control fluid flow because the pump heads do not make direct contact with fluid and will resist contamination, and because any non-sterile tubing can be easily cleaned or replaced for reusability. An exterior box housed the electronics, including a microcontroller system (ARDUINO®), potentiometers, power switches, lithium polymer (LiPo) batteries, and a liquid crystal display (LCD) screen showing flow rate, temperature, and time data. The peristaltic pumps were characterized and their properties were used to program the microcontroller to adjust the pumps at different speeds. The pump flow rate was characterized with respect to increasing control voltages as depicted in FIG. 10.

### Working Example #2

Eight meters of porcine intestine (4 meters from the distal end and 4 meters from the proximal end) were harvested in accordance with procedure described in A. Casavilla et al., “Logistics and technique for combined hepatic-intestinal retrieval,” 216 Ann. Surg. 605-09 (1992), and stored in a manner consistent with the standard of care to serve as a control. This tissue was placed in a plastic bag in an insulated cooler, surrounded by ice. The residual 3 meters of porcine intestine that remained en bloc were installed in the device described and depicted in Working Example #1.

The experimental piece of intestine inside the device was kept at between 4° C. and 8° C., which is the standard of care for transportation of organs. The device utilized two peristaltic pumps running at 160 mL/min. Tubing from the first pump conducted 0.9% saline solution from a 1 L IV bag through a closed system into the proximal end of porcine small intestine while tubing from the distal end of the intestine returned the fluid to the pump. A second pump and tubing conducted saline into the arterial inlet of the small intestine, the superior mesenteric artery. The intestinal tissue sat in a cold saline bath that collected solution from microperforations in the vasculature as well as the main venous outlet. This solution was passed through a metal screen before being delivered through a 180 μm filter to tubing that returned the solution to the second pump according to the architecture of FIG. 1. TYGON® [SILICONE?] tubing was used in the device, and conical barb (“Christmas Tree”) connectors were used along with sutures to connect the intestine to the tubing. Temperature and flow rate were monitored for 8 hours.

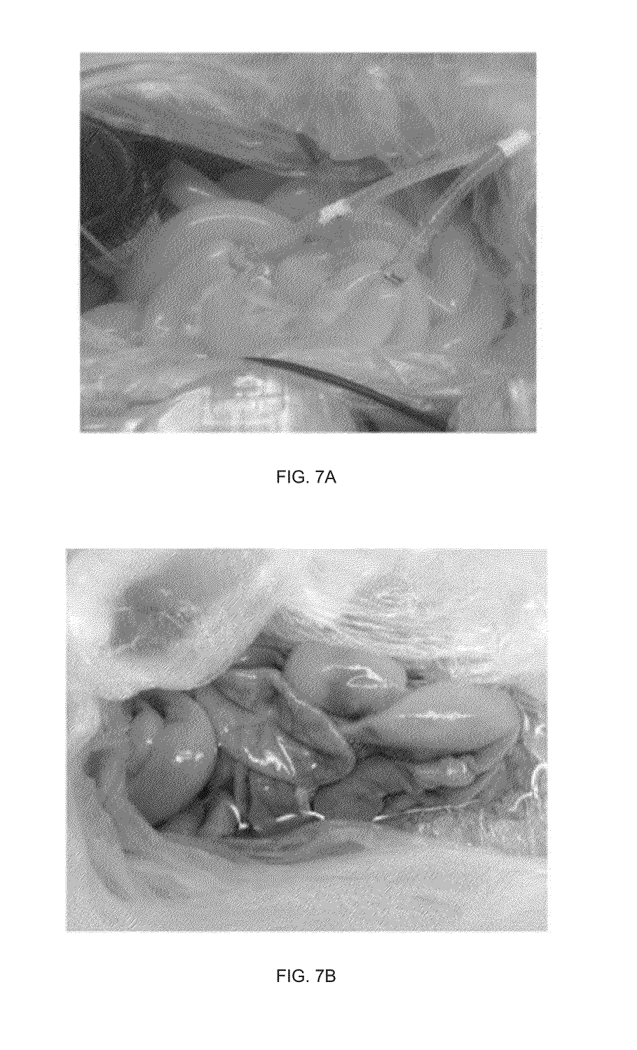

Circuitous flow was achieved through both the lumen and vasculature. After eight hours, the experimental lumen had not distended or suffered any apparent physical damage as seen in FIG. 7A. Meanwhile, the control, which had not been flushed out, had a visible buildup of waste products and several sections of the bowel had collapsed upon itself as seen in FIG. 7B.

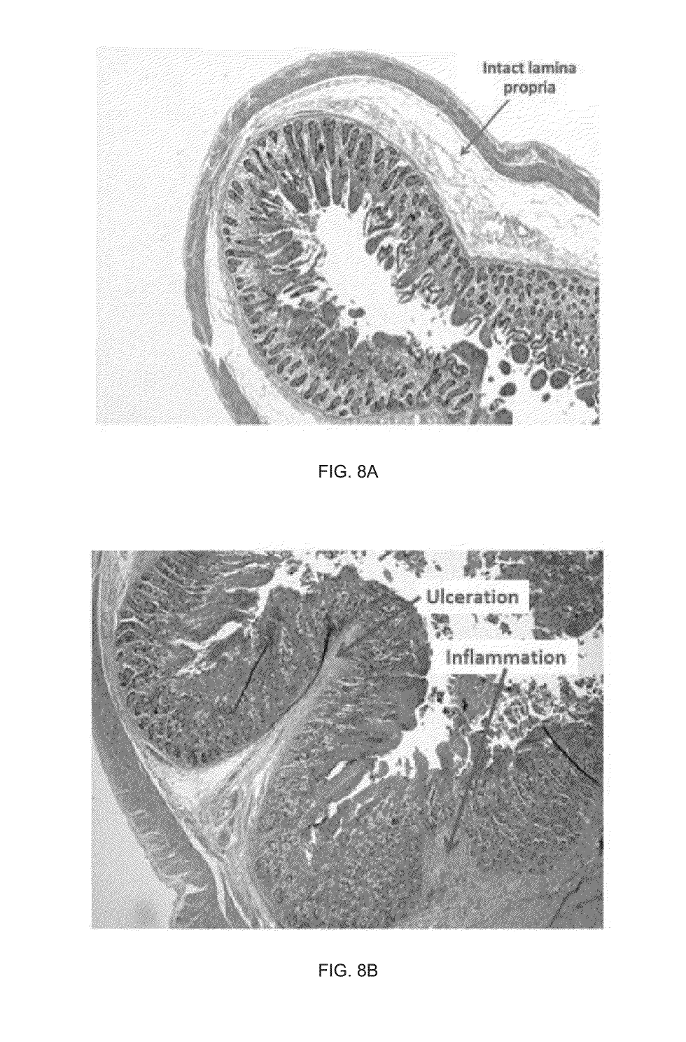

Two histology images stained with hematoxylin and eosin are shown in FIGS. 8A and 8B. The control image (FIG. 8B) shows significant inflammation, while the experimental tissue depicted in FIG. 8A has almost none. The control tissue had signs of focal early ulceration; the experimental tissue did not have any.

Overall, there was significantly less epithelial damage in the experimental tissue than in the control. According to these parameters, the embodiment of the invention preserved the intestine better than the standard of care.

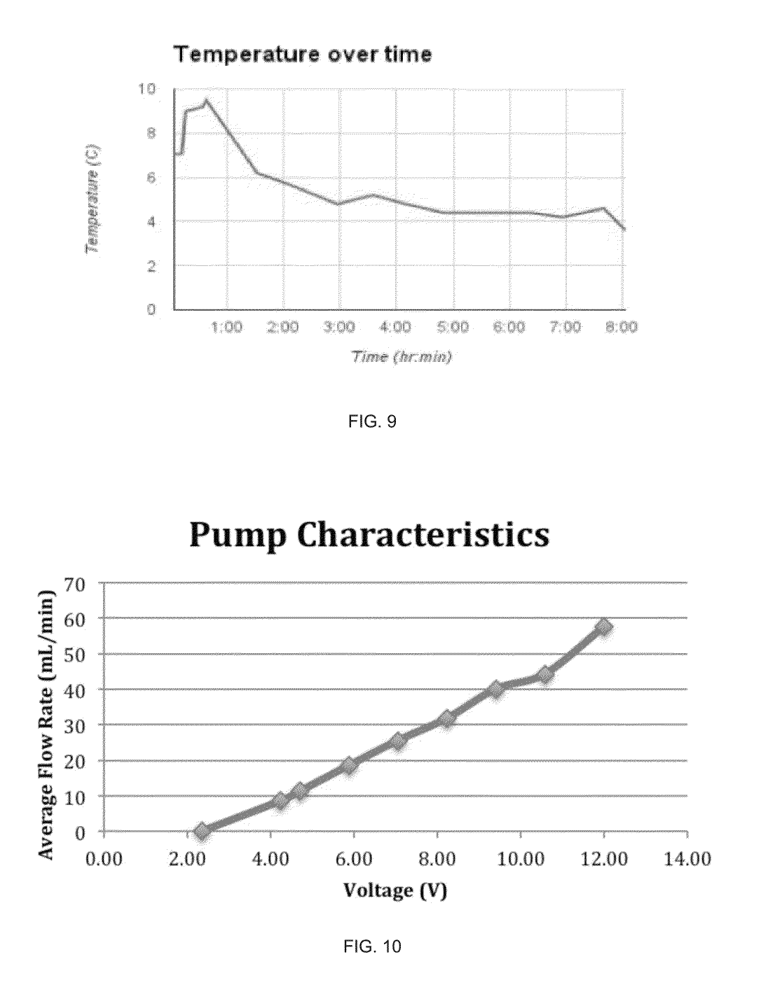

The organ was kept at a constant temperature between 4° C. and 8° C. during the 8 hour experiment as depicted in FIG. 9. This demonstrates that ice as a passive cooling method is effective at keeping the organ at the desired temperature.

The invention described herein addresses a gap in intestine transport preservation that has inhibited intestine transplants, causing them to represent only a small fraction of the 28,000 organ transplants performed in 2012. The invention would both substantially improve patient outcomes as well as help grow the prominence of intestinal transplants.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A perfusion system comprising:
a first circuit adapted and configured to circulate a first perfusate through a lumen of a small intestine; and
a second circuit adapted and configured to circulate a second perfusate through one or more blood vessels of the small intestine.

2. The perfusion system of claim 1, wherein the first circuit comprises:
a first perfusate reservoir;
a first length of tubing coupled to the first perfusate reservoir;
a second length of tubing coupled to the first perfusate reservoir; and
a first pump adapted and configured to circulate the first perfusate from the first perfusate reservoir to the first length of tubing and through the lumen of the small intestine to the second length of tubing.

3. The perfusion system of claim 2, further comprising:
a first fitting coupled to the first length of tubing and adapted and configured to form a substantially fluid-tight coupling with a first end of the lumen of the small intestine; and
a second fitting coupled to the second length of tubing and adapted and configured to form a substantially fluid-tight coupling with a second end of the lumen of the small intestine.

4. The perfusion system of claim 3, wherein the first fitting and the second fitting are Christmas tree fittings.

5. The perfusion system of claim 2, wherein the first pump is a peristaltic pump.

6. The perfusion system of claim 1, wherein the second circuit comprises:
a second perfusate reservoir;
a third length of tubing coupled to the second perfusate reservoir;
a fourth length of tubing coupled to the second perfusate reservoir; and
a second pump adapted and configured to circulate the second perfusate from the second perfusate reservoir to the third length of tubing, and through the one or more blood vessels of the small intestine to the fourth length of tubing.

7. The perfusion system of claim 6, further comprising:
a third fitting coupled to the third length of tubing and adapted and configured to form a substantially fluid-tight coupling with a first end of the one or more blood vessels of the small intestine; and
a fourth fitting coupled to the fourth length of tubing and adapted and configured to form a substantially fluid-tight coupling with a second end of the one or more blood vessels of the small intestine.

8. The perfusion system of claim 7, wherein the third fitting and the fourth fitting are Christmas tree fittings.

9. The perfusion system of claim 6, wherein the second pump is a peristaltic pump.

10. A method of perfusing at least a portion of a small intestine, the method comprising:
circulating a first perfusate through a lumen of the small intestine; and
circulating a second perfusate through a blood vessel of the small intestine.

11. The method of claim 10, wherein the second perfusate is recovered both from a vein and from a container below the small intestine.

12. The method of claim 10, wherein the first perfusate and the second perfusate are circulated simultaneously.

13. The method of claim 10, wherein the first perfusate and the second perfusate have a substantially identical composition.

14. The method of claim 10, wherein the first perfusate and the second perfusate are hypothermic perfusates.

15. The method of claim 14, wherein the first perfusate and the second perfusate are maintained between about 4° C. and about 8° C.

16. The method of claim 10, wherein the first perfusate and the second perfusate are room temperature perfusates.

17. The method of claim 10, wherein the first perfusate and the second perfusate are normothermic perfusates.

18. A perfusion system comprising:
a first circuit adapted and configured to circulate a first perfusate through a lumen of a small intestine;
a second circuit adapted and configured to circulate a second perfusate through one or more blood vessels of the small intestine; and
a container adapted and configured to hold the small intestine and collect perfusate that leaks from the small intestine, the container in fluidic communication with the second circuit so that the collected perfusate is recirculated through one or more blood vessels of the small intestine.
